(19) United States
(12) Patent Application Publication
(10) Pub. No.: US 2005/0220950 A1
(43) Pub. Date: Oct. 6, 2005

(54) Method of extracting effective ingredients from plant or mushroom

(76) Inventor: Yukio Kakuta, Arakawa-ku (JP)

Correspondence Address: JAMES C. WRAY, 1493 CHAIN BRIDGE ROAD, SUITE 300, MCLEAN, VA, 22101, US

(21) Appl. No.: 11/071,184

(22) Filed: Mar. 4, 2005

(30) Foreign Application Priority Data
Mar. 10, 2004 (JP) 2004-67192

(51) Int. Cl. A23P 1/00

(52) U.S. Cl. 426/481

(57) ABSTRACT

Effective ingredients can be efficiently extracted from materials such as plant and mushroom by the following method. The extracting method is characterized that cell-membranes are destructed by treating the materials with heated oil, before extracting the effective ingredients with the aid of an extracting agent.

### BACKGROUND OF THE INVENTION

1. Field of the Invention

The present invention relates to a method of extracting effective ingredients from plant or mushroom.

2. Brief Description of the Related Art

A recycled multistage pressurized extraction method has been known as a conventional method to extract effective ingredients.

Such a method disclosed in a Japanese patent registered No. 3212278, comprises the following steps: extracting essence of plant or mushroom by a pressurized hot water extractor; separating hydrated solid from extracted liquid by a water separator; treating the hydrated solid with saturated steam; extracting essence from the hydrated solid again by the pressurized hot water extractor and thickening the extracted liquid by a vacuum thickener.

This method is characterized by that the extracting step under pressurized hot water is repeated several times on different extracting conditions (temperature, pressure), namely, pressurized hot water extracting steps with different conditions are applied to plant or mushroom in accordance with strengths of cell-membranes of plant or mushroom, so that the cell-membranes which resist water used as an extracting agent to pass through are decomposed, as a result, essence can be extracted easily.

As described above, in the recycled multistage pressurized extraction method, since “pressurized hot water extracting step” is repeated such that cell-membranes of plant or mushroom are decomposed by the pressurized hot water treatments, effective ingredients can be extracted in a relatively short period compared with a decocting method which is usually employed in the traditional Chinese medicine.

However, since the recycled multistage pressurized extraction comprises a lot of treatment steps, the method requires a considerable amount of time and costs. As a result, extracted quantity per unit time is small, in other words, an extracting efficiency of the method is poor.

### SUMMARY OF THE INVENTION

The present invention is carried out to solve the problems of the conventional extracting methods and to raise efficiencies for extracting effective ingredients of plant or mushroom.

A method, which can solve the above-mentioned problems, for extracting the effective ingredients of plant or mushroom provided by the present invention is characterized by that cell-membranes of a material, namely, plant or mushroom, are destructed by a heat treatment with heated cooking oil, before the effective ingredients are extracted from the material with the aid of an extracting agent.

The above-mentioned heat treatment with the aid of the cooking oil is attained by applying the heated oil to the material. The heat treatment is realized, for example, by mixing the powdered or crushed material with the heated oil or by passing the unprocessed material through the heated oil.

Temperature and quantity of the oil and time for the heat treatment are determined in accordance with a contacting status between the material and the oil, and a type of the material, in other words, in accordance with a strength of cell-membranes of the material.

The oil is heated to a temperature in the range of 100° C.˜300° C., at which the cell-membranes can be destructed.

The cell-membranes should not to be destructed excessively in order to avoid effective ingredients from being decomposed in the cells by the heated oil.

Water is used as the above-mentioned extracting agent. If specific effective ingredients are required, a solvent having large solubility against such required effective ingredients can be employed as the extracting agent.

The following methods (1) and (2) described more specifically for extracting effective ingredients from plant or mushroom can solve the problems mentioned above.
(1) (a) pulverizing a plant or mushroom material;
   (b) immersing the pulverized material in hot water having a volume ca. two times as that of the material so as to soak cell-membranes of the material;
   (c) taking the immersed material out of the hot water and dehydrating the material;
   (d) adding oil heated in the range of 100° C.˜300° C. to the dehydrated material so as to destruct cell-membranes of the dehydrated material;
   (e) adding water of 10 times of volume as that of a mixed solution obtained in step (d) into the mixed solution and heating the mixed solution under pressurized hot water for two hours in an autoclave so as to extract effective ingredients from the material;
   (f) filtering the heated mixed solution so as to separate oil-bearing hydrated solid from oil-bearing liquid extracted by water; and
   (g) removing oil from the oil-bearing liquid extracted by water so as to obtain liquid extracted by water.
(2) (a) pulverizing a plant or mushroom material;
   (b) immersing the pulverized material in hot water having a volume ca. two times as that of the material so as to soak cell-membranes of the material;
   (c) taking the immersed material out of the hot water and dehydrating the material;
   (d) adding oil heated in the range of 100° C.˜300° C. to the dehydrated material so as to destruct cell-membranes of the dehydrated material;
   (e) adding water of 10 times of volume as that of a mixed solution obtained in step (d) into the mixed solution and heating the mixed solution under pressurized hot water for two hours in an autoclave so as to extract effective ingredients from the material; and
   (f) filtering the heated mixed solution so as to separate oil-bearing hydrated solid from oil-bearing liquid extracted by water so that the oil-bearing hydrated solid is obtained.

### DETAILED DESCRIPTION OF THE PREFERRED EMBODIMENT

Hereinafter, a preferred embodiment by the present invention is explained.

The embodiment is a method of extracting effective ingredients from bear bamboo grass (Sasa veitchii). Hereinafter, treatment steps of the method are explained in order.

(1) The bear bamboo grass is pulverized so as to obtain powder having an average diameter of 0.5 mm.

(2) 50 kg of the pulverized bear bamboo grass is immersed in hot water (80° C.) with a volume around two times as that of the pulverized bear bamboo grass and kept overnight so as to soak cell-membranes of the bear bamboo grass. Alternatively, the pulverized bear bamboo grass can be kept overnight after being heated in an autoclave. The bear bamboo grass immersed in water overnight is dehydrated by a dehydrator.

(3) 150 kg of cooking oil (salad oil) heated at 180° C. is added to the dehydrated pulverized bear bamboo grass and mixed. The mixture is kept for 10 minutes so as to destruct cell-membranes of the pulverized bear bamboo grass.

(4) The heated mixture of the pulverized bear bamboo grass and the cooking oil is put into an autoclave and water having 10 times of volume as that of the mixture is added in the autoclave and mixed with the mixture. Then the autoclave is kept for two hours at 110° C. so as to extract effective ingredients from the pulverized bear bamboo grass.

(5) The heated mixed solution in the autoclave is filtered so as to separate oil-bearing hydrated solid from oil-bearing liquid extracted by water. And oil is removed from the oil-bearing liquid extracted by water so as to obtain liquid extracted by water.

(6) When water functioning as extracting agent is removed by heating the obtained liquid extracted by water, essence of the bear bamboo grass, dense fluid is obtained.

(7) Since the oil-bearing hydrated solid contains effective ingredients of the bear bamboo grass, it is employed as an additive to livestock feed. Since the removed oil also contains effective ingredients of the bear bamboo grass, it is employed as one of the materials for soap, shampoo, aromatic oil and cosmetics.

As mentioned above, in the extracting method of the present embodiment, since cell-membranes which resist water used as extracting agent to pass through, are destructed by the heated cooking oil (salad oil) beforehand, the succeeding step to extract effective ingredients from the bear bamboo grass can be carried out easily.

As a result, the effective ingredients can be extracted efficiently from the bear bamboo grass for a brief operating period at a low cost without repeating extracting steps by the method of the present embodiment.

In the present embodiment, the method applied to the bear bamboo grass for extracting effective ingredients is explained, but the method can be also applied to ginseng (Panax schinseng), turmeric, green tea, Japanese cypress, aloe and the like.

It is difficult to extract effective ingredients from materials such as herb roots having hard cell-membrane, animal bones such as deer bones, rock when ordinary water, alcohol and the like are used as extracting agents. However, when these materials are pulverized and then treated by heated oil, the effective ingredients can be extracted. Cell-membranes also can be destructed by liquid nitrogen.

In the present embodiment, the extracting method which employs cooking oil is explained, but other oils for fuel, industrial use and the like can be also employed.

According to the present invention, since cell-membranes are destructed by heated oil beforehand, the cell membranes do not resist effective ingredients to be extracted.

Consequently, extracting efficiency can be raised without repeating the time and cost consuming pressurized hot water extraction as the conventional extracting methods did.

1. A method of extracting effective ingredients from plant or mushroom comprising steps of:
(a) pulverizing a plant or mushroom material;
(b) immersing said pulverized material in hot water having a volume ca. two times as that of said material so as to soak cell-membranes of said material;
(c) taking said immersed material out of the hot water and dehydrating said material;
(d) adding oil heated in the range of 100° C.˜300° C. to said dehydrated material so as to destruct cell-membranes of said dehydrated material;
(e) adding water of 10 times of volume as that of a mixed solution obtained in preceding step into said mixed solution and heating said mixed solution under pressurized hot water for two hours in an autoclave so as to extract effective ingredients from said material;
(f) filtering said heated mixed solution so as to separate oil-bearing hydrated solid from oil-bearing liquid extracted by water; and
(g) removing oil from said oil-bearing liquid extracted by water so as to obtain liquid extracted by water.

2. A method of extracting effective ingredients from plant or mushroom comprising steps of:
(a) pulverizing a plant or mushroom material;
(b) immersing said pulverized material in hot water having a volume ca. two times as that of said material so as to soak cell-membranes of said material;
(c) taking said immersed material out of the hot water and dehydrating said material;
(d) adding oil heated in the range of 100° C.˜300° C. to said dehydrated material so as to destruct cell-membranes of said dehydrated material;
(e) adding water of 10 times of volume as that of a mixed solution obtained in the preceding step into said mixed solution and heating said mixed solution under pressurized hot water for two hours in an autoclave so as to extract effective ingredients from said material; and
(f) filtering said heated mixed solution so as to separate oil-bearing hydrated solid from oil-bearing liquid extracted by water so that the oil-bearing hydrated solid is obtained.
